(19) United States
(12) Patent Application Publication
(10) Pub. No.: US 2021/0362728 A1
(43) Pub. Date: Nov. 25, 2021

(54) DRIVING SKILL EVALUATION SYSTEM AND DRIVING SKILL EVALUATION METHOD

(71) Applicants: SUBARU CORPORATION, Tokyo (JP); Future Corporation, Tokyo (JP)

(72) Inventors: Noeru SATO, Tokyo (JP); Takeshi TORII, Tokyo (JP); Shun TANAKA, Tokyo (JP); Masaaki KOBASHI, Tokyo (JP); Shota TSUKAMOTO, Tokyo (JP)

(21) Appl. No.: 17/324,732

(22) Filed: May 19, 2021

(30) Foreign Application Priority Data
May 21, 2020 (JP) 2020-088532

(51) Int. Cl. B60W 40/09; G07C 5/04; B60W 50/14; B62D 6/08

(52) U.S. Cl. CPC B60W 40/09; G07C 5/04; B60W 50/14; B62D 6/08; B60W 2720/106; B60W 2540/10; B60W 2540/12; B60W 2540/18; B60W 2710/207

(57) ABSTRACT

A driving skill evaluation system configured to evaluate a driving skill of a driver includes a correction operation detection unit configured to detect a correction operation of a driving operation of the driver, a cause estimation unit configured to perform an estimation of a cause of the correction operation based on vehicle traveling state information at a time point when the correction operation is performed and vehicle traveling state information at time points before a predetermined period and after a predetermined period of the time point when the correction operation is performed, and an evaluation unit configured to evaluate the driving skill of the driver based on a result of the estimation.

### CROSS-REFERENCE TO RELATED APPLICATIONS

This application is based on and claims priority under 35 USC 119 from Japanese Patent Application No. 2020-088532 filed on May 21, 2020, the contents of which are incorporated herein by reference.

The present disclosure relates to a driving skill evaluation system.

There is known a device that evaluates a driving skill of a driver based on a driving operation of an automobile. For example, Japanese Unexamined Patent Application Publication (JP-A) No. 2014-135061 discloses a driving evaluation device that detects a vehicle state quantity that changes in accordance with a driving operation of a driver, creates a driving model as an index of a specific driving operation based on a vehicle state quantity when the driver starts a specific driving operation and a vehicle state quantity when the driver finishes a specific driving operation, and evaluates a driving skill of the driver by comparing a driving operation of the driver indicated by a detection result of a vehicle state quantity and the driving model.

JP-A No 2017-218055 discloses a driving support device that evaluates and notifies respective driving skills for a plurality of types of driving operations of a driver, such as a steering operation, a brake operation, and an accelerator operation. Specifically, a technique has been proposed in which operation states of a steering wheel, an accelerator pedal, and a brake pedal are accumulated for a certain period of time, and a driving evaluation point is calculated by comparing an operation state of an expert driver read from a database and an operation state of a driver stored in the database.

### SUMMARY

The present disclosure relates to a driving skill evaluation system configured to evaluate a driving skill of a driver. The driving skill evaluation system includes a correction operation detection unit configured to detect a correction operation of a driving operation of the driver, a cause estimation unit configured to perform an estimation of a cause of the correction operation based on vehicle traveling state information at a time point when the correction operation is performed and vehicle traveling state information at time points before a predetermined period and after a predetermined period of the time point, and an evaluation unit configured to evaluate the driving skill of the driver based on a result of the estimation.

The present disclosure also relates to a driving skill evaluation method. The method includes: detecting a correction operation in a driving operation of a driver; performing an estimation of a cause of the correction operation based on vehicle traveling state information at a time point when the correction operation is performed and vehicle traveling state information at time points before a predetermined period and after a predetermined period of the time point when the correction operation is performed; and evaluating a driving skill of the driver based on a result of the estimation.

The present disclosure also relates to a driving skill evaluation system configured to evaluate a driving skill of a driver and including a circuitry. The circuitry is configured to: detect a correction operation in a driving operation of the driver; perform an estimation of a cause of the correction operation based on vehicle traveling state information at a time point when the correction operation is performed and vehicle traveling state information at time points before a predetermined period and after a predetermined period of the time point; and evaluate the driving skill of the driver based on a result of the estimation.

### BRIEF DESCRIPTION OF DRAWINGS

The accompanying drawings are included to provide a further understanding of the disclosure and are incorporated in and constitute a part of this specification. The drawings illustrate an embodiment and, together with the specification, serve to explain the principles of the disclosure.

FIG. 1 is a block diagram showing a configuration example of a driving skill evaluation system according to an embodiment.

FIG. 2 is a diagram showing an example of a correction operation cause list input during machine learning.

FIG. 3 is a diagram showing a method of detecting a correction operation of a steering operation.

FIG. 4 shows an example of a distance threshold and an operation time that are set according to a traveling scene.

FIG. 5 is a diagram showing a method of detecting a correction operation of an operation for adjusting a front-rear direction acceleration.

FIG. 6 is a diagram showing an example of a display for notifying a driving skill evaluation result.

FIG. 7 is a flowchart showing an example of a processing of the driving skill evaluation system according to the embodiment.

FIG. 8 is a flowchart showing an example of a processing of detecting a correction operation of a steering operation.

FIG. 9 is a flowchart showing an example of a processing of detecting a correction operation of an operation for adjusting a front-rear direction acceleration.

FIG. 10 is a block diagram showing a configuration example of a driving skill evaluation system using a management server.

### DESCRIPTION OF EMBODIMENTS

A driving skill may not always be evaluated appropriately only by comparing a driving operation with a learning model or an operation state or the like of an expert driver as disclosed in JP-A Nos. 2014-135061 and 2017-218055.

It is desirable to provide an automobile driving skill evaluation system capable of improving evaluation accuracy.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. Driving Skill Evaluation System

First, a driving skill evaluation system according to the embodiments will be schematically described.

A system that evaluates a driving skill of a driver based on a content of a driving operation of an automobile is considered to be important to achieve a society of safe driving. However, it is difficult to uniformly specify driving operations with a high driving skill. For example, there is an individual difference in a cornering operation and the like even for skilled drivers. When a driver having a high driving skill drives a vehicle, it can be considered that a passenger may feel at ease on the vehicle. However, it is difficult to uniformly specify driving in which a passenger may feel at ease on the vehicle. Therefore, a specific operation in a certain scene is set as a correct answer, and when an operation deviating from a driving operation serving as the correct answer is evaluated as a problem, a driving skill may not be appropriately evaluated.

Therefore, in the driving skill evaluation system according to the embodiments, “driving in which a vehicle can be operated according to an intention of a driver and corrections for a driving operation is few” is regarded as “driving with a high driving skill”, and the driving skill evaluation system is configured to detect a correction operation of a driving operation of the driver and estimate a cause of the correction operation. In addition, the driving skill evaluation system according to the embodiments is configured to evaluate a driving skill of the driver based on the estimated cause of the correction operation, and make a notification for feeding back an evaluation result to the driver.

Although a technique for evaluating a driving operation of a vehicle by a driver or a vehicle behavior that appears along with a driving operation has been proposed, a technique for considering an operation that causes a correction operation is not proposed. In the driving skill evaluation system according to the embodiments, information about steering, a steering angle of a wheel, and a front-rear direction acceleration is used as information for detecting a correction operation of a driving operation. Examples of an operation in which a driving operation of the driver can affect a vehicle behavior include a steering operation, a brake operation, and an accelerator operation. Therefore, an influence on the vehicle behavior by the driving operation of the driver can be detected and a correction operation of the driving operation can be estimated, by detecting a steering angle and a front-rear direction acceleration in time series. The driving skill evaluation system according to the embodiments can estimate an operation that causes a correction operation, so that a basic driving skill of the driver can be evaluated.

### 2. Configuration Example of Driving Skill Evaluation System

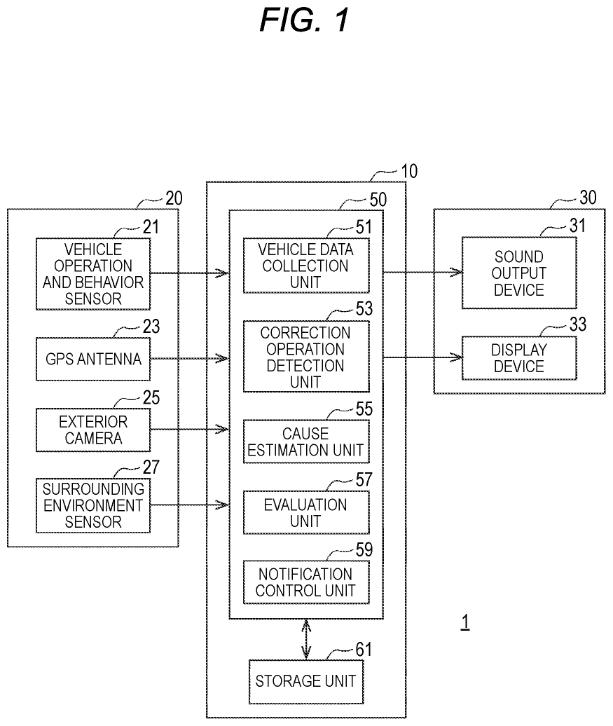

Next, a configuration example of the driving skill evaluation system according to the embodiments will be described. FIG. 1 is a block diagram showing a configuration example of a driving skill evaluation system 1 according to the embodiments.

The driving skill evaluation system 1 includes a driving skill evaluation device 10, a detection device 20, and a notification unit 30. The driving skill evaluation system 1 is mounted on a vehicle. The detection device 20 collects various kinds of vehicle data used for evaluating a driving skill and outputs the vehicle data to the driving skill evaluation device 10. The driving skill evaluation device 10 evaluates a driving skill of a driver based on the collected vehicle data. The notification unit 30 notifies the driver of a driving skill evaluation result from the driving skill evaluation device 10.

2-1 Detection Device

The detection device 20 includes a vehicle operation and behavior sensor 21, a GPS antenna 23, an exterior camera 25, and a surrounding environment sensor 27. The vehicle operation and behavior sensor 21, the GPS antenna 23, the exterior camera 25, and the surrounding environment sensor 27 are connected to the driving skill evaluation device 10 directly or via a communication unit such as a controller area network (CAN) or a local Internet (LIN).

2-1-1 Vehicle Operation and Behavior Sensor

The vehicle operation and behavior sensor 21 includes at least one sensor that detects an operation state and a behavior of the vehicle. In the embodiments, the vehicle operation and behavior sensor 21 detects at least a front-rear direction acceleration, an accelerator operation amount, a brake operation amount, and a steering angle. For example, the vehicle operation and behavior sensor 21 includes an acceleration sensor, an accelerator position sensor, a brake stroke sensor, and a steering angle sensor. The steering angle sensor may be a sensor that detects a steering angle of a steering wheel, or may be a sensor that detects a steering angle of a wheel. Hereinafter, information detected by the vehicle operation and behavior sensor 21 is collectively referred to as vehicle control information. The vehicle operation and behavior sensor 21 transmits the detected vehicle control information to the driving skill evaluation device 10. The vehicle operation and behavior sensor 21 may include a sensor that detects an operation state or a behavior of the vehicle other than those described above.

2-1-2 GPS Antenna

The GPS antenna 23 receives a satellite signal from global positioning system (GPS) satellites. The GPS antenna 23 transmits position information in vehicle map data included in the received satellite signal to the driving skill evaluation device 10. Instead of the GPS antenna 23, the driving skill evaluation system 1 may include an antenna that receives a satellite signal from another satellite system that specifies a position of the vehicle.

2-1-3 Exterior Camera

The exterior camera 25 generates image data obtained by imaging surroundings of the vehicle. The exterior camera 25 may be mounted for a safety function of the vehicle or for collecting information used for evaluating a driving skill. The exterior camera 25 includes, for example, an imaging element such as a charge coupled device (CCD) and a complementary metal oxide semiconductor (CMOS), and transmits generated image data to the driving skill evaluation device 10. The exterior camera 25 includes one or more cameras that can capture an image in at least one direction of the vehicle including a front direction, a side direction, and a rear direction.

2-1-4 Surrounding Environment Sensor

The surrounding environment sensor 27 is a sensor that detects a person or an obstacle surrounding the vehicle. The surrounding environment sensor 27 includes, for example, one or more of a high-frequency radar sensor, an ultrasonic sensor, and a LiDAR. Examples of a detected obstacle include another vehicle, a bicycle, a building, a traffic sign, traffic lights, a natural object, and any other objects present surrounding the vehicle.

2-2 Notification Unit

The notification unit 30 includes a sound output device 31 and a display device 33. The sound output device 31 is driven by the driving skill evaluation device 10 and notifies a driving skill evaluation result using a sound. The sound output device 31 may be a speaker of an audio system mounted on the vehicle, or may be a speaker dedicated to the driving skill evaluation system 1. The display device 33 is driven by the driving skill evaluation device 10 and notifies a driving skill evaluation result by displaying an image. The display device 33 may be a display provided in an instrument panel, may be a display of a navigation system, or may be a display dedicated to the driving skill evaluation system 1.

2-3 Driving Skill Evaluation Device

The driving skill evaluation device 10 includes a control unit 50 and a storage unit 61. A part or the entire of the control unit 50 is implemented by, for example, an arithmetic processing device such as a central processing unit (CPU) and a micro processing unit (MPU) and an image processing device such as a graphic processing unit (GPU). Alternatively, a part or the entire of the control unit 50 may be implemented by an updatable firmware or the like, or may be a program module or the like executed according to a command from a CPU or the like.

2-3-1 Storage Unit

The storage unit 61 is implemented by a storage element such as a random access memory (RAM) and a read only memory (ROM), or a storage medium such as a hard disk drive (HDD), a compact disc (CD), a digital versatile disc (DVD), a solid state drive (SSD), a universal serial bus (USB) flash, and a storage device. The storage unit 61 stores a software program to be executed by the control unit 50, various parameters used in an arithmetic processing, acquired information, an arithmetic result, and the like.

In addition, the storage unit 61 stores a correction operation cause model prepared in advance. That is, the correction operation cause model is generated in advance by machine learning using, for example, a computer different from the driving skill evaluation device 10, and then the correction operation cause model is stored in the storage unit 61. The correction operation cause model is a learning model including, as input data, vehicle traveling scene information at a time point when a correction operation is performed, vehicle control information at time points before a predetermined period and after a predetermined period of the time point when the correction operation is performed, vehicle surrounding environment information at time points before a predetermined period and after a predetermined period of the time point when the correction operation is performed, and a cause of the correction operation.

The vehicle traveling scene information is traveling environment data classified according to a traveling speed of the vehicle that is mainly assumed, and is classified into highway traveling, normal road traveling, narrow road traveling in a residential area, parking lot traveling, and the like. The vehicle control information is data corresponding to the above-described information detected by the vehicle operation and behavior sensor 21. The vehicle control information includes at least data of a front-rear direction acceleration, an accelerator operation amount, a brake operation amount, and a steering angle. The vehicle surrounding environment information is data corresponding to the above-described information detected by the GPS antenna 23 or the surrounding environment sensor 27. The vehicle surrounding environment information includes data of at least another vehicle, a pedestrian, a bicycle, and other obstacles that may affect a speed or a traveling direction of the vehicle.

The vehicle control information and the surrounding environment information at the time points before a predetermined period and after a predetermined period of the time point when the correction operation is performed use data at appropriate time points before and after the time point when the correction operation is performed, so as to improve accuracy of a generated learning model. A time interval is preferably set in consideration of, for example, how far ahead a general driver is driving while the vehicle is traveling. For example, data of 2.5 seconds before the time point when the correction operation is performed and 2.5 seconds after the time point when the correction operation is performed can be used. How far ahead a driver can see can be changed depending on whether the vehicle travels on a straight road or a curved road. Therefore, the time interval may be different corresponding to an assumed traveling road.

Various reasons can be considered as causes of a correction operation. In the embodiments, a cause of a correction operation due to a driving skill of a driver includes a cause related to a steering operation, a cause related to an accelerator operation, a cause related to a brake operation, and a cause related to a vehicle speed. In particular, in a steering operation, when an operation is performed at timing before a correction operation is actually performed, the operation is considered as an operation that causes a correction operation.

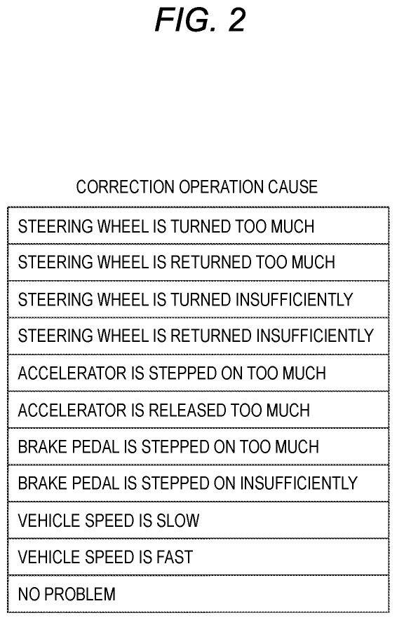

FIG. 2 is a diagram showing an example of a correction operation cause list.

Causes related to a steering operation include the following causes.
steering wheel is turned too much
steering wheel is returned too much
steering wheel is turned insufficiently
steering wheel is returned insufficiently

Causes related to an accelerator operation include the following causes.
accelerator is stepped on too much
accelerator is released too much

Causes related to a brake operation include the following causes.
brake pedal is stepped on too much
brake pedal is stepped on insufficiently

Causes related to a vehicle speed include the following causes.
vehicle speed is slow
vehicle speed is fast

A cause of a correction operation may be due to a driving skill of a driver, or may be due to an unavoidable operation in a traveling environment of the vehicle. Therefore, an option of “no problem” is also provided as a cause of a correction operation due to an unavoidable operation in a traveling environment of the vehicle in order to avoid coming into contact with a traffic participant, an obstacle, or the like in the surroundings.

As described above, the driving skill evaluation system 1 according to the embodiments uses information about a steering angle and a front-rear direction acceleration as information used for detecting a correction operation of a driving operation. Examples of an operation in which a driving operation of a driver can affect a vehicle behavior include a steering operation, a brake operation, and an accelerator operation. Therefore, the correction operation cause list shown in FIG. 2 includes causes related to a steering operation, a brake operation, and an accelerator operation.

In the driving skill evaluation system 1 according to the present embodiment, as a preliminary preparation, a plurality of data sets are prepared as input data (learning data) for generating a correction operation cause model by machine learning, and the correction operation cause model is generated by performing machine learning. Each data set includes, for example, data of vehicle traveling scene information, data of vehicle control information, and data of vehicle surrounding environment information at a time point when a correction operation of a driving operation is performed while the vehicle is traveling, and data of a cause of the correction operation in a case where the above-described pieces of data are collected. These data sets may be data collected during a vehicle actually travels, or may be data prepared by simulation or the like.

2-3-2 Control Unit

The control unit 50 includes a vehicle data collection unit 51, a correction operation detection unit 53, a cause estimation unit 55, an evaluation unit 57, and a notification control unit 59. The control unit 50 executes various arithmetic processings by executing programs stored in the storage unit 61. In one example, each unit of the control unit 50 is a function implemented by executing a program by an arithmetic processing device or an image processing device.

2-3-2-1 Vehicle Data Collection Unit

The vehicle data collection unit 51 collects various kinds of vehicle data based on an output signal from the detection device 20. In one example, the vehicle data collection unit 51 collects at least data of vehicle control information such as a front-rear direction acceleration, an accelerator operation amount, a brake operation amount, and a steering angle based on an output signal from the vehicle operation and behavior sensor 21, and stores the data in the storage unit 61. The vehicle data collection unit 51 collects data of a position of the vehicle on map data based on an output signal from the GPS antenna 23, and stores the data in the storage unit 61.

The vehicle data collection unit 51 collects data of a surrounding environment of the vehicle based on output signals from the exterior camera 25 and the surrounding environment sensor 27, and stores the data in the storage unit 61. For example, the vehicle data collection unit 51 executes an image processing on image data transmitted from the exterior camera 25, specifies a person, another vehicle, a bicycle, a building, a natural object, or the like present surrounding the vehicle by using an object detection technique, and calculates a position of an object relative to the vehicle, a distance between the vehicle and the object, and a relative speed of the vehicle to the object. Alternatively, the vehicle data collection unit 51 may specify an object present surrounding the vehicle and calculate a position of the object relative to the vehicle, a distance between the vehicle and the object, and a relative speed of the vehicle to the object, based on a sensor signal transmitted from the surrounding environment sensor 27.

The vehicle data collection unit 51 may acquire information transmitted from a device outside the vehicle via a communication unit such as vehicle-to-vehicle communication, road-to-vehicle communication, and a mobile communication network, and specify a part of data of a surrounding environment of the vehicle. The vehicle data collection unit 51 may specify a position of the vehicle on map data by using vehicle position information acquired by the GPS antenna 23 and specify a part of the vehicle surrounding environment information.

The vehicle data collection unit 51 stores the collected data in the storage unit 61 as time-series data.

2-3-2-2 Correction Operation Detection Unit

The correction operation detection unit 53 detects a correction operation of a driving operation of a driver. As described above, in the driving skill evaluation system 1 according to the present embodiment, the correction operation detection unit 53 is configured to detect a correction operation of a driving operation using information about a steering angle and a front-rear direction acceleration.

[Detection of Correction Operation of Steering Operation]

When a correction operation of a steering operation for adjusting a steering angle is detected, the correction operation detection unit 53 detects the correction operation of the steering operation based on information about a change in a steering angle over time. In one example, after a turning direction of a steering wheel is switched between turning from right to left and turning from left to right, when a rotation amount of the steering wheel in a direction after the switching is equal to or larger than a predetermined switching-back determination threshold, the correction operation detection unit 53 determines that a steering switching-back that is a change in the turning direction of the steering wheel occurs. For example, after a turning direction of the steering wheel is switched from right to left, when the steering wheel is rotated in a left direction by a certain angle, the correction operation detection unit 53 determines that “an operation of turning the steering wheel to the right was changed to an operation of turning the steering wheel to the left”. However, it is necessary to distinguish a steering operation that naturally occurs when the vehicle travels along a traveling road at the time of cornering or the like from the correction operation of the steering operation. Therefore, after a steering switching-back from one direction to another direction is detected, when a steering switching-back from the another direction to the one direction is detected before a travel distance reaches a predetermined distance threshold, the correction operation detection unit 53 detects a correction operation of a steering operation.

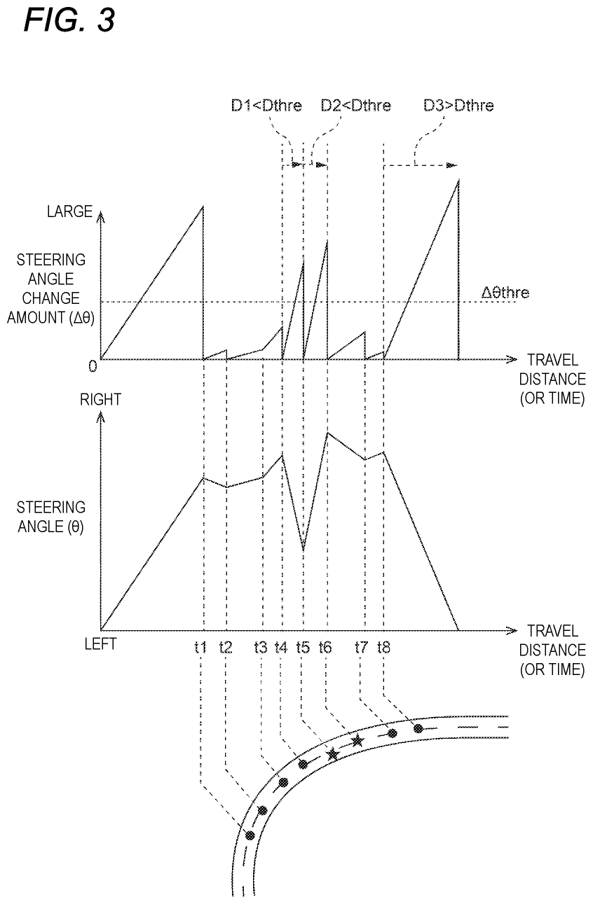

FIG. 3 is a diagram showing a method of detecting a correction operation of a steering operation. Positions of the vehicle at time points t1 to t8 when the vehicle passes through a right curve are shown at a lower side in FIG. 3. Of two graphs shown in FIG. 3, the lower graph shows steering angles θ at the time points t1 to t8 and the upper graph shows steering angle change amounts Δθ from time points when a steering angle is reversed to the left or the right.

In the example shown in FIG. 3, a turning direction of the steering wheel is switched from left to right or from right to left at time points t1, t2, t4, t5, t6, t7, and t8. At time points t4, t5, and t8, a steering angle change amount Δθ after the switching exceeds a preset switching-back determination threshold Δθthre. Therefore, the correction operation detection unit 53 determines that a steering switching-back occurs at the time points t4, t5, and t8. In this case, the correction operation detection unit 53 determines that a steering switching-back does not occur at time points t1, t2, t6, and t7 when a steering angle change amount Δθ does not exceed the switching-back determination threshold Δθthre after a turning direction of the steering wheel is switched.

After a steering switching-back occurs at the time point t4 and before a travel distance D1 reaches a predetermined distance threshold Dthre, a steering switching-back occurs again at the time point t5. Therefore, the correction operation detection unit 53 detects a series of operations from the time point t4 to the time point t5 and from the time point t5 to the time point t6 as a correction operation of a steering operation. On the other hand, after a steering switching-back occurs at the time point t5 and before a travel distance D2 reaches the predetermined distance threshold Dthre, a turning direction of the steering wheel is switched at the time point t6, but it is determined that a steering switching-back does not occur again at the time point t6. Therefore, a series of operations from the time point t5 to the time point t6 and from the time point t6 to the time point t7 are not detected as a correction operation of a steering operation. Further, a steering switching-back occurs, a travel distance D3 from an occurrence of a steering switching-back to an occurrence of a steering switching-back again exceeds the predetermined distance threshold Dthre at the time point t8, and the correction operation detection unit 53 does not detect an operation after the time point t8 as a correction operation of a steering operation.

The switching-back determination threshold Δθthre for determining an occurrence of a steering switching-back can be set to an appropriate value based on data of a magnitude of a variation of a steering operation of, for example, a driver assumed to have a general skill level. When a steering device of the vehicle is configured to adjust operability (a weight of a steering wheel) according to a vehicle speed, the switching-back determination threshold Δθthre may be changed according to a speed of a vehicle during traveling.

Similarly, the distance threshold Dthre for determining a correction operation of a steering operation can be set to an appropriate value based on data of a travel distance up to when, for example, a driver assumed to have a general skill level corrects a steering operation. At this time, the distance threshold Dthre may be a variable value set according to a traveling scene of the vehicle. This is because a travel distance D from the occurrence of a steering switching-back to an occurrence of a steering switching-back again differs depending on a vehicle speed.

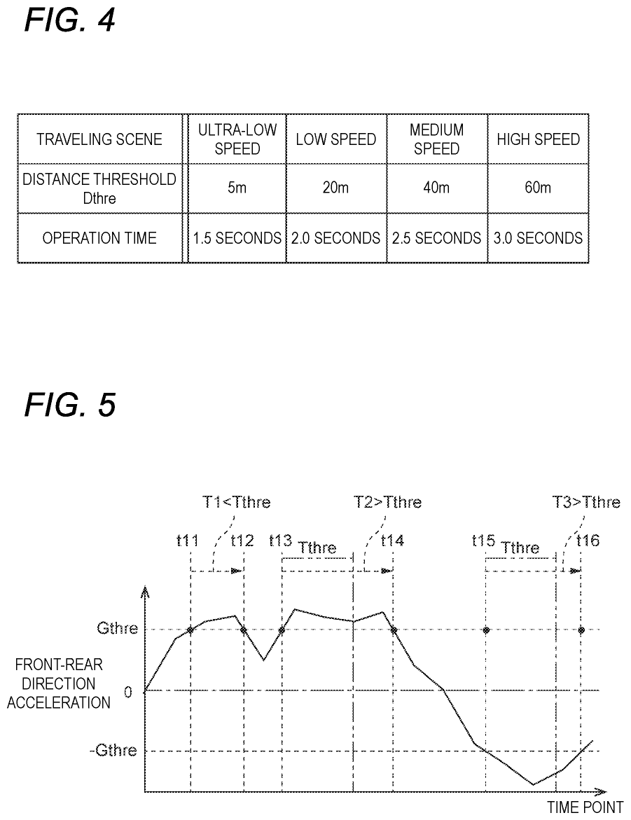

FIG. 4 shows an example of the distance threshold Dthre set according to a traveling scene. In the example shown in FIG. 4, traveling scenes are classified into “ultra-low speed”, “low speed”, “medium speed”, and “high speed”. The “ultra-low speed” is, for example, a traveling scene assumed when a vehicle travels in a parking lot. The “low speed” is, for example, a traveling scene assumed when a vehicle travels on a narrow road in a residential area. The “medium speed” is, for example, a traveling scene assumed when a vehicle travels on a normal road. The “high speed” is, for example, a traveling scene assumed when a vehicle travels on a highway. A distance threshold Dthre for the “ultra-low speed” is set to 5 m. A distance threshold Dthre for the “low speed” is set to 20 m. A distance threshold Dthre for the “medium speed” is set to 40 m. A distance threshold Dthre for the “high speed” is set to 60 m.

A traveling scene can be estimated based on, for example, vehicle position information acquired using the GPS antenna 23, information about an average vehicle speed in a predetermined distance range set in advance, vehicle surrounding environment information acquired using the exterior camera 25, or the like. The correction operation detection unit 53 sets the distance threshold Dthre according to an estimated traveling scene and then, after a steering switching-back from one direction to another direction is detected, when the correction operation detection unit 53 detects a steering switching-back from the another direction to the one direction before the travel distance D reaches the distance threshold Dthre, the correction operation detection unit 53 detects a correction operation of a steering operation.

Instead of a travel distance from an occurrence of a steering switching-back to an occurrence of a steering switching-back again, an operation time may be used as a criterion for determining a correction operation of a steering operation. For example, after the correction operation detection unit 53 detects a steering switching-back from one direction to another direction, the correction operation detection unit 53 may detect a correction operation of a steering operation when the correction operation detection unit 53 detects a steering switching-back from the another direction to the one direction within a predetermined period of operation time.

Similarly, the operation time for determining a correction operation of a steering operation can be set to an appropriate value based on data of operation time up to when, for example, a driver assumed to have a general skill level corrects a steering operation. In this case, the operation time may be a variable value set according to a traveling scene of the vehicle. This is because operation time from the occurrence of a steering switching-back to an occurrence of a steering switching-back again differs depending on a vehicle speed. In the example shown in FIG. 4, an operation time of the “very low speed” is set to 1.5 seconds, an operation time of the “low speed” is set to 2.0 seconds, an operation time of the “medium speed” is set to 2.5 seconds, and an operation time of “high speed” is set to 3.0 seconds.

[Detection of Correction Operation of Operation for Adjusting Front-Rear Direction Acceleration]

When a correction operation of an operation for adjusting a front-rear direction acceleration is detected, the correction operation detection unit 53 detects the correction operation of an operation for adjusting a front-rear direction acceleration based on information about a change in the front-rear direction acceleration over time. In one example, the correction operation detection unit 53 detects the correction operation of an operation for adjusting a front-rear direction acceleration when the correction operation detection unit 53 detects that an elapsed time starting from when an acceleration exceeds a predetermined acceleration threshold Gthre equals to a predetermined period of time. A rapid accelerator operation and a brake operation that are correction operations of an operation for adjusting a front-rear direction acceleration directly lead to an increase in the front-rear direction acceleration. Therefore, it is a condition that a front-rear direction acceleration exceeds the predetermined acceleration threshold Gthre. The correction operation detection unit 53 is configured to detect a correction operation of an operation for adjusting a front-rear direction acceleration when an acceleration continuously exceeds the acceleration threshold Gthre for a predetermined period of time, so that the correction operation detection unit 53 does not determine a case where a front-rear direction acceleration is increased for a very short period of time as a correction operation regardless of whether the case is a correction operation.

FIG. 5 is a diagram showing a method of detecting a correction operation of an operation for adjusting a front-rear direction acceleration. FIG. 5 shows an example of a change in a front-rear direction acceleration over time. The acceleration threshold Gthre is set to 0.2 for an acceleration and −0.2 for a deceleration (negative acceleration). The acceleration threshold Gthre is set to an appropriate value based on an acceleration during a period of time in which an acceleration or a deceleration larger than a normal front-rear direction acceleration occurs.

In the example shown in FIG. 5, accelerations exceed the acceleration threshold Gthre at time points t11 and t13. An acceleration is reduced to the acceleration threshold Gthre before an elapsed time T1 starting from when an acceleration at the time point t11 exceeds the acceleration threshold Gthre reaches a preset time threshold Tthre. On the other hand, an elapsed time T2 starting from when an acceleration at the time point t13 exceeds the acceleration threshold Gthre exceeds the time threshold Tthre. Therefore, the correction operation detection unit 53 detects a series of operations from the time point t13 to the time point t14 as a correction operation of an operation for adjusting a front-rear direction acceleration. In this case, the correction operation detection unit 53 does not detect a series of operations from the time point t11 to the time point t12 as a correction operation of an operation for adjusting a front-rear direction acceleration.

At a time point t15, a deceleration is lower than a deceleration threshold Gthre. An elapsed time T3 starting from when a deceleration at the time point t15 is smaller than the deceleration threshold Gthre exceeds the time threshold Tthre. Therefore, the correction operation detection unit 53 detects a series of operations from the time point t15 to a time point t16 as a correction operation of an operation for adjusting a front-rear direction acceleration.

Similarly, the time threshold Tthre for determining a correction operation of an operation for adjusting a front-rear direction acceleration can be set to an appropriate value based on data of an operation time used when, for example, a driver assumed to have a general skill level corrects an accelerator operation or a brake operation. At this time, the time threshold Tthre may be a variable value set according to a traveling scene of the vehicle. This is because that a speed adjustment range is different between an urban area where a vehicle is repeatedly stopped and started and a highway where a vehicle travels at a constant speed, and an operation time is considered to be longer in the urban area where a vehicle is stopped and started.

In this manner, in the driving skill evaluation system 1 according to the embodiments, the correction operation detection unit 53 detects a correction operation of a steering operation and a correction operation of an operation for adjusting a front-rear direction acceleration. A method of detecting the correction operation of a steering operation and the correction operation of an operation for adjusting a front-rear direction acceleration is not limited to the one described in the above example, and other methods may be used.

2-3-2-3 Cause Estimation Unit

The cause estimation unit 55 estimates a cause of a correction operation based on vehicle traveling state information at a time point when the correction operation detected by the correction operation detection unit 53 is performed and vehicle traveling state information at time points before a predetermined period and after a predetermined period of the time point when the correction operation is performed. In the embodiments, the cause estimation unit 55 uses a correction operation cause model stored in the storage unit 61 to estimate a cause of a correction operation performed by a driver based on vehicle data stored in the storage unit 61.

As described above, the correction operation cause model is generated by machine learning using, as input data, vehicle traveling scene information at the time point when the correction operation is performed, vehicle control information at time points before a predetermined period and after a predetermined period of the time point when the correction operation is performed, vehicle surrounding environment information at time points before a predetermined period and after a predetermined period of the time point when the correction operation is performed, and a cause of the correction operation. Therefore, the vehicle traveling scene information at the time point when the correction operation detected by the correction operation detection unit 53 is performed is used as the vehicle traveling state information at the time point when the correction operation is performed. The cause estimation unit 55 extracts data corresponding to the time point when the correction operation is performed from traveling scene data stored in the storage unit 61.

The vehicle control information at time points before a predetermined period and after a predetermined period of the time point when the correction operation detected by the correction operation detection unit 53 is performed, and the vehicle surrounding environment information at time points before a predetermined period and after a predetermined period of the time point when the correction operation is performed are used as the vehicle traveling state information at time points before a predetermined period and after a predetermined period of the time point when the correction operation is performed. The cause estimation unit 55 extracts vehicle data at a corresponding time point from vehicle data stored in the storage unit 61 according to setting of a time interval used when the correction operation cause model is generated. The time interval starting from a time point when the correction operation is performed in the extracted vehicle data may be constant, or may be different depending on a traveling road such as a straight road or a curved road.

The “time point when the correction operation is performed” is set to any time point within a period of time (for example, time point t4 to time point t5 and time point t5 to time point t6 in FIG. 3) from starting to ending of the correction operation detected by the correction operation detection unit 53. For example, the “time point when the correction operation is performed” is a time point (for example, time point t5 in FIG. 3) when, after a steering switching-back is performed from one direction to another direction, a steering switching-back is performed from the another direction to the one direction before a travel distance reaches a predetermined distance threshold. In addition, the “time point when the correction operation is performed” may be a time point (for example, time point t4 in FIG. 3) when a series of correction operations are started. The “time point when the correction operation is performed” may be a time point (for example, time point t6 in FIG. 3) when a series of correction operations are finished. The “time point when the correction operation is performed” may be an intermediate time point in a period of time when a series of correction operations are performed. Further, the “time point when the correction operation is performed” may be “a period of time when the correction operation is performed”. A time point before a predetermined period of the time point when the correction operation is performed may be a time point before a predetermined period of a time point (for example, time point t4 in FIG. 3) when a series of correction operations are started, and a time point after a predetermined period of the time point when the correction operation is performed may be a time point after a predetermined period of a time point (for example, time point t6 in FIG. 3) when the correction operations are finished.

The cause estimation unit 55 inputs, to the correction operation cause model, the extracted data of a vehicle traveling scene at the time point when the correction operation is performed, the extracted data of the vehicle control information at time points before a predetermined period and after a predetermined period of the time point when the correction operation is performed, the extracted data of the vehicle surrounding environment at time points before a predetermined period and after a predetermined period of the time point when the correction operation is performed, and the cause estimation unit 55 calculates a cause of the correction operation. In the embodiments, one cause in the correction operation cause list shown in FIG. 2 is calculated as a cause of the correction operation.

2-3-2-4 Evaluation Unit

The evaluation unit 57 evaluates a driving skill of a driver based on an estimation result of the cause of a correction operation from the cause estimation unit 55. An evaluation method is not particularly limited. For example, the evaluation method may be an evaluation method of reducing a point each time when a correction operation of an operation for adjusting a steering operation or a front-rear direction acceleration is detected.

For example, when there is no correction operation for a driving operation, the evaluation unit 57 may set a perfect score, and each time when a correction operation of a driving operation is detected, the evaluation unit 57 may perform a negative evaluation. In this case, the evaluation unit 57 does not perform a negative evaluation on a driving skill when a correction operation cause estimation result from the cause estimation unit 55 is “no problem”, and the evaluation unit 57 performs a negative evaluation on a driving skill when a correction operation cause estimation result is a cause due to a driving skill other than “no problem”. In one example, when there is no correction operation for a driving operation, the evaluation unit 57 set 100 points, and each time when a correction operation of a driving operation is detected and a cause of the correction operation is a cause other than “no problem”, the evaluation unit 57 subtracts 10 points.

2-3-2-5 Notification Control Unit

The notification control unit 59 controls driving of the notification unit 30 to cause the notification unit 30 to notify a driver driving skill evaluation result evaluated by the evaluation unit 57. In the embodiments, the notification control unit 59 controls the display device 33 to display the driving skill evaluation result and controls the sound output device 31 to output a sound for notifying the driving skill evaluation result. For example, the notification control unit 59 may notify the driving skill evaluation result when a driving skill evaluation is finished, and may notify the driving skill evaluation result in response to a request from a driver or the like.

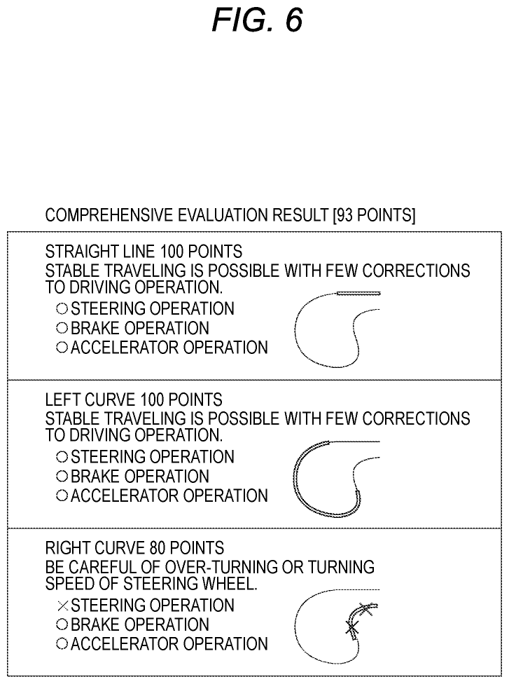

FIG. 6 shows an example of a display that is displayed on the display device 33 and is used for notifying a driving skill evaluation result. In the example of the display shown in FIG. 6, driving skill evaluation results when a vehicle travels along a straight line, a left curve, and a right curve are displayed together with a comprehensive evaluation result. Evaluation points of the driving skill evaluation results for the straight line, the left curve, and the right curve are results obtained by setting 100 points as a perfect score and subtracting 10 points each time when a correction operation due to a cause other than “no problem” is detected. An evaluation point of the comprehensive evaluation result is an average point of the driving skill evaluation results for the straight line, the left curve, and the right curve.

FIG. 6 shows an example of evaluation results in a case where no correction operation due to a cause other than “no problem” is detected when the vehicle travels along the straight line and the left curve while a correction operation due to a steering operation is detected twice when the vehicle travels along the right curve. Therefore, evaluation points for the straight line and the left curve are 100 points, and an evaluation point for the right curve is 80 points. As a result, a comprehensive evaluation result is 93 points.

In the example of the display shown in FIG. 6, the evaluation result also includes a notification of a piece of advice for a driving operation. For the straight line and the left curve in which no correction operation due to a cause other than “no problem” is detected, texts “stable traveling is possible with few corrections to a driving operation” are displayed, and “o” is attached to each of a “steering operation”, a “brake operation”, and an “accelerator operation”. On the other hand, for the right curve in which a correction operation due to a steering operation is detected twice, texts “be careful of over-turning or turning speed of a steering wheel” based on the cause are displayed. Further, “o” is attached to each of a “brake operation” and an “accelerator operation” and “x” is attached to a “steering operation”.

Travel sections in which a driving skill is evaluated for the straight line, the left curve, and the right curve are shown in the example of the display shown in FIG. 6. For the right curve in which a correction operation due to a steering operation is detected, a vehicle position at a time point when the correction operation is performed is indicated by “x” on a traveling road. Therefore, a driver can know a position where a correction operation of a driving operation is performed, and can easily recognize a point where a driving skill evaluation of the driver is low.

In addition to the display shown in FIG. 6, the notification control unit 59 controls the sound output device 31 to notify a part or all of display contents using a sound. Notification of a driving skill evaluation result may be performed by only one of the sound output device 31 and the display device 33. Alternatively, an evaluation result can be notified using both a sound output and a display, so that a driver can easily understand the evaluation result, which may contribute to improvement of a driving skill.

The configuration example of the driving skill evaluation system 1 according to the embodiments has been described above. A driving skill evaluation using the driving skill evaluation system 1 may be started when an ignition switch is turned on during normal use of a vehicle, and may be ended when the ignition switch is turned off. Alternatively, a driving skill evaluation using the driving skill evaluation system 1 may be started according to a starting setting of a driver and may be ended according to an ending setting of the driver.

A driving skill evaluation using the driving skill evaluation system 1 may be performed using data collected during a travel period satisfying a preset travel condition, and may be performed using data collected during traveling on a specified test course or the like. Further, a driving skill evaluation using the driving skill evaluation system 1 may be performed in real time when a vehicle travels, and may be performed at appropriate timing using vehicle data accumulated during traveling of the vehicle.

### 3. Operation Example of Driving Skill Evaluation System

Next, an operation example of the driving skill evaluation device 10 of the driving skill evaluation system 1 according to the embodiments will be described.

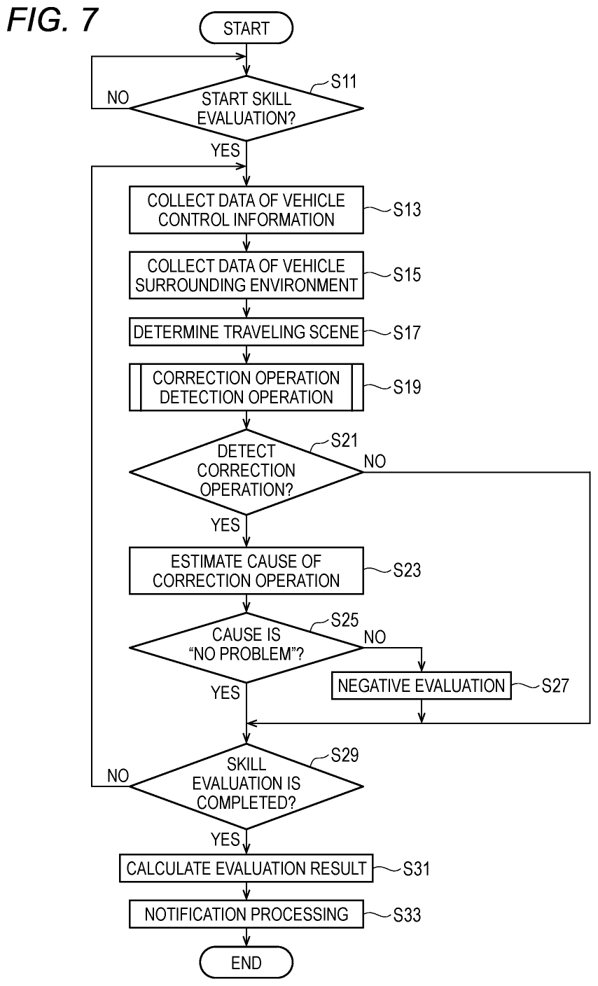

FIG. 7 is a flowchart showing an example of a processing executed by the control unit 50 of the driving skill evaluation device 10. An operation example described below is an example in which vehicle data is collected during a period of time from when a predetermined starting condition of a driving skill evaluation is satisfied to when an ending condition is satisfied and a driving skill evaluation is executed in real time.

First, the evaluation unit 57 of the control unit 50 determines whether a starting condition of a driving skill evaluation is satisfied (step S11). For example, the starting condition may be a condition when an ignition switch is turned on, and may be an evaluation starting setting operated by a driver or the like on an operation switch, a touch panel, or the like. When the starting condition is not satisfied (S11/No), the evaluation unit 57 repeats the determination in step S11 until it is determined that the starting condition is satisfied.

When the starting condition is satisfied (S11/Yes), the vehicle data collection unit 51 collects data of the vehicle control information such as at least a front-rear direction acceleration, an accelerator operation amount, a brake operation amount, and a steering angle based on an output signal from the vehicle operation and behavior sensor 21 (step S13). In the embodiments, the vehicle data collection unit 51 also collects data of a vehicle position on map data based on an output signal from the GPS antenna 23. The vehicle data collection unit 51 collects the data of the vehicle control information and the data of the vehicle position for each preset processing cycle, and stores the data in the storage unit 61 as time-series data.

Next, the vehicle data collection unit 51 collects data of a vehicle surrounding environment based on output signals from the exterior camera 25 and the surrounding environment sensor 27 (step S15). For example, the vehicle data collection unit 51 specifies a person, an object, or the like present in the surroundings of the vehicle, and calculates positions of these objects relative to the vehicle, distances between the vehicle and these objects, and relative speeds of the vehicle to these objects. The vehicle data collection unit 51 may specify a part of the data of the vehicle surrounding environment by using information transmitted from a device outside the vehicle via a communication unit such as vehicle-to-vehicle communication, road-to-vehicle communication, or a mobile communication network, or using vehicle position information acquired by the GPS antenna 23. The vehicle data collection unit 51 collects the data of the vehicle surrounding environment for each preset processing cycle, and stores the data in the storage unit 61 as time-series data.

Next, the correction operation detection unit 53 determines a vehicle traveling scene based on the vehicle data collected in step S13 and step S15 (step S17). For example, the correction operation detection unit 53 can estimate a traveling scene based on vehicle position information acquired using the GPS antenna 23, information about an average vehicle speed in a predetermined distance range set in advance, vehicle surrounding environment information acquired using the exterior camera 25, or the like.

Next, the correction operation detection unit 53 executes a processing of detecting a correction operation of a driving operation based on the vehicle data accumulated in the storage unit 61 (step S19). In the embodiments, the correction operation detection unit 53 detects a correction operation of a steering operation and a correction operation of an operation for adjusting a front-rear direction acceleration. Hereinafter, an example of a processing of detecting each of a correction operation of a steering operation and a correction operation of an operation for adjusting a front-rear direction acceleration will be described.

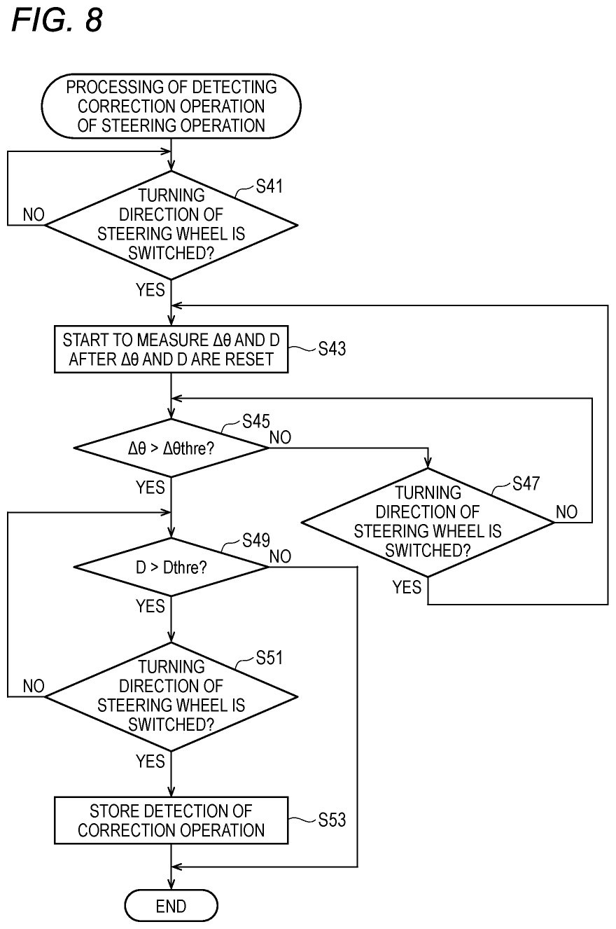

FIG. 8 is a flowchart showing an example of the processing of detecting a correction operation of a steering operation.

The correction operation detection unit 53 determines whether a turning direction of a steering wheel is switched from right to left or from left to right based on steering angle data (step S41). When the turning direction of the steering wheel is not switched (S41/No), the correction operation detection unit 53 repeats the determination in step S41. When the turning direction of the steering wheel is switched from right to left or from left to right (S41/Yes), the correction operation detection unit 53 resets values of a steering angle change amount Δθ and a travel distance D, and starts to measure the steering angle change amount Δθ from a time point when the turning direction of the steering wheel is switched and the travel distance D from the time point when the turning direction of the steering wheel is switched (step S43).

Next, the correction operation detection unit 53 determines whether the steering angle change amount Δθ exceeds a preset steering-back determination threshold Δθthre (step S45). When a vehicle steering device is configured to adjust operability (weight of the steering wheel) according to a vehicle speed, the correction operation detection unit 53 may change the switching-back determination threshold Δθthre according to the vehicle speed.

When the steering angle change amount Δθ is equal to or less than the switching-back determination threshold Δθthre (S45/No), the correction operation detection unit 53 determines whether the turning direction of the steering wheel is switched (step S47). In step S47, the correction operation detection unit 53 determines whether a steering angle is reversed in a direction opposite to a reversing direction of the steering angle detected in step S41. When the turning direction of the steering wheel is switched (S47/Yes), the correction operation detection unit 53 returns the processing to step S43, resets values of the steering angle change amount Δθ and the travel distance D, and starts to measure the steering angle change amount Δθ from the time point when the turning direction of the steering wheel is switched and the travel distance D from the time point when the turning direction of the steering wheel is switched (step S43).

On the other hand, when the turning direction of the steering wheel is not switched (S47/No), the correction operation detection unit 53 returns the processing to step S45, and repeats the determination for determining whether the steering angle change amount Δθ exceeds the steering-back determination threshold Δθthre (step S45). When the steering angle change amount Δθ exceeds the switching-back determination threshold Δθthre (S45/Yes), the correction operation detection unit 53 determines whether the travel distance D is less than a preset distance threshold Dthre (step S49). In the embodiments, the correction operation detection unit 53 sets the distance threshold Dthre according to the vehicle traveling scene determined in step S17 as shown in FIG. 4.

Instead of determining whether the travel distance D is less than the distance threshold Dthre, the correction operation detection unit 53 may determine whether an elapsed time starting from the time point when the turning direction of the steering wheel is switched is less than a predetermined period of operation time. In this case, the correction operation detection unit 53 sets the operation time according to the vehicle traveling scene determined in step S17 as shown in FIG. 4.

When the travel distance D reaches the distance threshold Dthre (S49/No), it is determined that a steering operation being performed is an operation that naturally occurs during driving, a routine is ended as it is, and the processing returns to step S41. On the other hand, when the travel distance D is less than the distance threshold Dthre (S49/Yes), the correction operation detection unit 53 determines whether the turning direction of the steering wheel is switched (step S51). In step S51, the correction operation detection unit 53 determines whether a steering angle is reversed in a direction opposite to a reversing direction of the steering angle detected previously in step S41 or step S47.

When the turning direction of the steering wheel is not switched (S51/No), the processing returns to step S49. On the other hand, when the turning direction of the steering wheel is switched (S51/Yes), the correction operation detection unit 53 determines that a correction operation of the steering operation is detected, and stores the detection of the correction operation in the storage unit 61 (step S53). The correction operation detection unit 53 stores the detection of the correction operation in association with a time point when the correction operation is detected, so that it is possible to specify vehicle traveling scene data at the time point when the correction operation is detected and vehicle data before and after the time point when the correction operation is detected.

In this manner, the correction operation detection unit 53 detects a correction operation of a steering operation by repeating the processing operations from step S41 to step S53, and stores the detection of the correction operation in the storage unit 61.

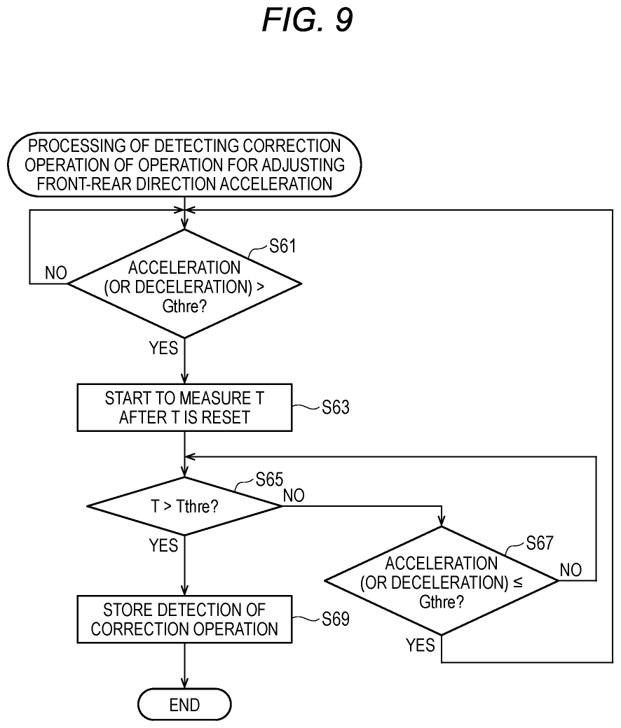

FIG. 9 is a flowchart showing an example of the processing of detecting a correction operation of an operation for adjusting a front-rear direction acceleration.

First, the correction operation detection unit 53 determines whether an acceleration (or a deceleration) exceeds a preset acceleration threshold Gthre based on front-rear direction acceleration data (step S61). In the embodiments, the acceleration threshold Gthre is set to an appropriate value based on an acceleration during a period of time in which an acceleration or a deceleration larger than a normal front-rear direction acceleration occurs.

When the acceleration (or the deceleration) is equal to or less than the acceleration threshold Gthre (S61/No), the correction operation detection unit 53 repeats the determination in step S61. When the acceleration (or the deceleration) exceeds the acceleration threshold Gthre (S61/Yes), the correction operation detection unit 53 resets a value of an elapsed time T and starts to measure the elapsed time T from a time point when the acceleration (or the deceleration) exceeds the acceleration threshold Gthre (step S63).

Next, the correction operation detection unit 53 determines whether the elapsed time T exceeds a preset time threshold Tthre (step S65). In the embodiments, the correction operation detection unit 53 sets the time threshold Tthre according to the vehicle traveling scene determined in step S17.

When the elapsed time T is equal to or less than the time threshold Tthre (S65/No), the correction operation detection unit 53 determines whether an acceleration (or the deceleration) is equal to or less than the acceleration threshold Gthre (step S67). When the acceleration (or the deceleration) is equal to or less than the acceleration threshold Gthre (S67/Yes), the correction operation detection unit 53 returns the processing to step S61 and determines whether the acceleration (or the deceleration) exceeds the acceleration threshold Gthre (step S61). On the other hand, when the acceleration (or the deceleration) exceeds the acceleration threshold Gthre (S67/No), the correction operation detection unit 53 returns the processing to step S65 and repeats the determination for determining whether the elapsed time T exceeds the time threshold Tthre (step S65).

When the elapsed time T exceeds the time threshold Tthre (S65/Yes), the correction operation detection unit 53 determines that a correction operation of an operation for adjusting a front-rear direction acceleration is detected, and stores the detection of the correction operation in the storage unit 61 (step S69). The correction operation detection unit 53 stores the detection of the correction operation in association with a time point when the correction operation is detected so that it is possible to specify vehicle traveling scene data at the time point when the correction operation is detected and vehicle data before and after the time point when the correction operation is detected.

In this manner, the correction operation detection unit 53 detects a correction operation of an operation for adjusting a front-rear direction acceleration by repeating the processing operations from step S61 to step S69, and stores the detection of the correction operation in the storage unit 61.

Return to FIG. 7. In step S21 subsequent to step S19, the cause estimation unit 55 determines whether a correction operation of a driving operation is detected by the correction operation detection unit 53 (step S21). When no correction operation of a driving operation is detected (S21/No), the processing proceeds to step S29. On the other hand, when a correction operation of a driving operation is detected (S21/Yes), the cause estimation unit 55 performs a processing of estimating a cause of the correction operation (step S23). In the embodiments, the cause estimation unit 55 uses, as input data, the data of the vehicle traveling scene at the time point when the correction operation is performed and the data of the vehicle control information and the vehicle surrounding environment at time points before a predetermined period and after a predetermined period of the time point when the correction operation is performed, and calculates a cause of the correction operation by using the correction operation cause model stored in the storage unit 61 in advance. Here, one cause in the correction operation cause list shown in FIG. 2 is calculated as the cause of the correction operation.

Next, the evaluation unit 57 determines whether the cause of the correction operation calculated by the cause estimation unit 55 is “no problem” (step S25). When the cause of the correction operation is “no problem” (S25/Yes), it is determined that the detected correction operation is an unavoidable operation in a traveling environment of the vehicle, and thus the evaluation unit 57 does not perform a negative evaluation for the driving skill and the processing proceeds to step S29.

On the other hand, when the cause of the correction operation is not “no problem” (S25/No), it is determined that the detected correction operation is caused by a steering operation, an accelerator operation, or a brake operation of a driver, and thus the evaluation unit 57 performs a negative evaluation for the driving skill and the processing proceeds to step S29. In the embodiments, the evaluation unit 57 records −10 points each time when a correction operation due to a driving skill of the driver is detected. At this time, negative evaluations are recorded separately for straight traveling, right curve traveling, and left curve traveling.

Next, in step S29, the evaluation unit 57 determines whether a condition for ending the driving skill evaluation is satisfied (step S29). For example, the ending condition may be a condition when an ignition switch is turned off, and may be an evaluation ending setting operated by the driver or the like on an operation switch, a touch panel, or the like. When the ending condition is not satisfied (S29/No), the processing returns to step S13, and the processings in steps described above are performed.

On the other hand, when the ending condition is satisfied (S29/Yes), the evaluation unit 57 calculates an evaluation result in a driving skill evaluation period (step S31). In the embodiments, the evaluation unit 57 subtracts a recorded minus point from 100 points to calculate evaluation points for the straight traveling, the right curve traveling, and the left curve traveling. The evaluation unit 57 sets an average point of the evaluation points for the straight traveling, the right curve traveling, and the left curve traveling as a comprehensive evaluation point.

Next, the notification control unit 59 generates a control signal for notifying a driving skill evaluation result, and transmits the control signal to the sound output device 31 and the display device 33 (step S33). For example, the notification control unit 59 extracts, together with information about the evaluation result calculated in step S31, data of a correction operation cause estimated for each of the straight traveling, the right curve traveling, and the left curve traveling, and data of a point where the correction operation is detected, and the notification control unit 59 generates and outputs a control signal of display data and corresponding sound data as shown in FIG. 6. Accordingly, a driving skill evaluation result is notified by the sound output device 31 and the display device 33, and a piece of advice or the like for improving a driving skill is output to the driver.

In the driving skill evaluation system according to the embodiments, the driving skill evaluation device 10 executes the above-described calculation processings in steps S11 to S33. Accordingly, a driver can objectively know a driving skill of the driver based on a correction operation of a driving operation and a cause of the correction operation, instead of a comparison with a single comparison target such as an operation state of a learning model or an expert driver. The driving skill evaluation device 10 provides a piece of advice based on the cause of the correction operation together with a driving skill evaluation result. Therefore, the driver can know a weak point or a habit of a driving operation of the driver, and can be aware to improve a driving skill.

### 4. Another Configuration Example

In the driving skill evaluation system 1 according to the embodiments described above, the correction operation cause model is stored in the storage unit 61 of the driving skill evaluation device 10, and the control unit 50 of the driving skill evaluation device 10 executes all processings such as the detection of the correction operation and the estimation of the cause of the correction operation. Alternatively, the driving skill evaluation system 1 may be implemented as a system that evaluates a driving skill of a driver and communicates with a management server via a wireless communication unit such as mobile communication.

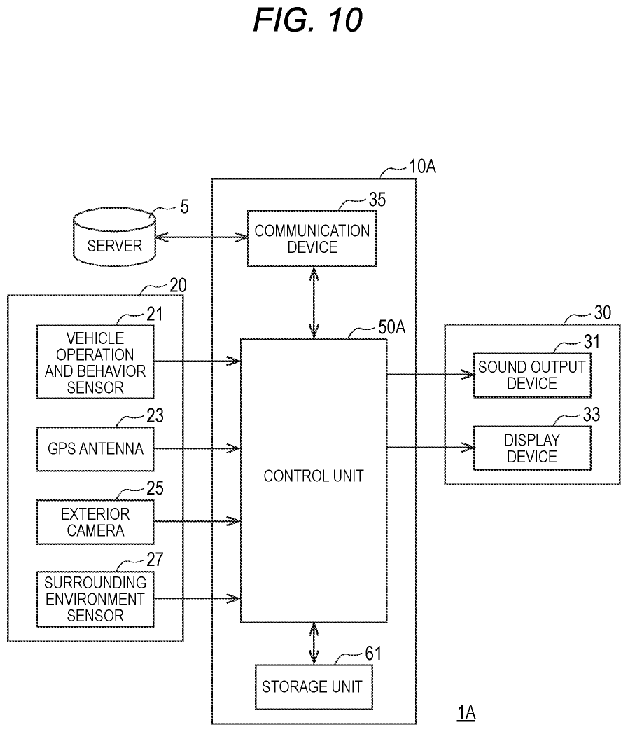

FIG. 10 is a block diagram showing a configuration example of a driving skill evaluation system 1A using a management server.

A management server 5 is, for example, a cloud server. The management server 5 includes a communication device for communicating with the driving skill evaluation device 10A mounted on a vehicle. The communication device is an interface for the management server 5 to communicate with the driving skill evaluation device 10A via a communication unit such as a mobile communication network. The management server 5 includes a storage device such as a storage element such as a RAM or a ROM, or a storage medium such as an HDD, a CD, a DVD, an SSD, a USB flash, and a storage device. The storage device stores at least a correction operation cause model. The management server 5 includes, for example, an arithmetic processing device such as a CPU. The arithmetic processing device executes various arithmetic processings by executing a program stored in the storage device.

In the driving skill evaluation system 1A including the management server 5, a driving skill evaluation device 10A includes a communication device 35 for communicating with the management server 5. The communication device 35 is an interface for the driving skill evaluation device 10A to communicate with the management server 5 via a communication unit such as a mobile communication network. A control unit 50A of the driving skill evaluation device 10A transmits information to and receives information from the management server 5 via the communication device 35.

The correction operation cause model stored in the storage unit 61 of the driving skill evaluation device 10 of the driving skill evaluation system 1 according to the embodiment described above is stored in the management server 5 in the driving skill evaluation system 1A. A part or all of functional configurations of the control unit 50 of the driving skill evaluation device 10 of the driving skill evaluation system 1 according to the embodiments described above is implemented by the arithmetic processing device of the management server 5.

According to the driving skill evaluation system 1A, it is possible to reduce a load of an arithmetic processing of the control unit 50A of the driving skill evaluation device 10A mounted on a vehicle. It is possible to accumulate results of arithmetic processings performed by the management server 5 using data collected by a plurality of vehicles. Therefore, it is possible to analyze a general tendency of driving operations of drivers or update the correction operation cause model by using data of driving operation habits of a plurality of drivers and data of a driving operation habit of an individual driver.

### 5. Summary

As described above, according to the driving skill evaluation system 1 in the embodiments, a correction operation of a driving operation of a driver is detected, a cause of the detected correction operation is estimated, and a driving skill of the driver is evaluated based on an estimation result. Therefore, the driving skill of the driver is evaluated based on a correction operation of a driving operation and a cause of the correction operation, instead of a comparison with a single comparison target such as an operation state of a learning model or an expert driver. Therefore, it is possible to provide a driving skill evaluation system with high evaluation accuracy.

The driving skill evaluation system 1 according to the present embodiment provides a piece of advice based on the cause of the correction operation together with a driving skill evaluation result. Therefore, the driver can know a weak point or a habit of a driving operation of the driver, and can be aware to improve a driving skill.

In the driving skill evaluation system 1 according to the embodiments, the cause of the correction operation is estimated using a correction operation cause model in which vehicle traveling scene information at a time point when a correction operation is performed, vehicle control information at time points before a predetermined period and after a predetermined period of the time point when the correction operation is performed, vehicle surrounding environment information at time points before a predetermined period and after a predetermined period of the time point when the correction operation is performed, and a cause of the correction operation are used as input data. Therefore, a cause of an actually occurred correction operation can be estimated with high accuracy based on data indicating a difference between a driving operation of a driver having a high skill level and few correction operations and a driving operation of a driver having a low skill level and many correction operations and data of a cause of the correction operation. Therefore, it is possible to improve accuracy of a driving skill evaluation result.

In the driving skill evaluation system 1 according to the embodiments, even when a correction operation of a driving operation is detected, a negative evaluation is not performed on a driving skill when the operation is an unavoidable operation in a vehicle traveling environment. Therefore, it is possible to improve reliability of evaluating a driving skill for a correction operation due to a driving skill of a driver.

In the driving skill evaluation system 1 according to the embodiments, based on the data of the vehicle control information, a correction operation of a steering operation and a correction operation of an operation for adjusting a front-rear direction acceleration are detected and a driving skill is evaluated. Therefore, a driving skill of a driver can be evaluated based on a driving operation in which a driving operation of the driver can be reflected in vehicle behaviors, and reliability of an evaluation result can be improved.

In the driving skill evaluation system 1 according to the embodiments, thresholds used for detecting a correction operation of a steering operation and a correction operation of an operation for adjusting a front-rear direction acceleration are set according to a vehicle traveling scene. Therefore, a correction operation of a driving operation can be detected using an appropriate threshold corresponding to a vehicle traveling scene, in particular, a vehicle speed, and detection accuracy of the correction operation can be improved. Therefore, it is possible to improve reliability of a driving skill evaluation result.

Although preferred embodiments of the present invention have been described above in detail with reference to the accompanying drawings, the present invention is not limited thereto. It will be apparent to those skilled in the art who have common knowledge in the technical field to which the present invention belongs that various changes and modifications can be conceived within the scope of the technical idea described in the claims. It is also to be understood that those changes and modifications belong to the technical scope of the present invention.

For example, in the embodiment described above, correction operations of a steering operation, an accelerator operation, and a brake operation of a driver are detected, and a driving skill is evaluated. The present invention is not limited to such an example. A correction operation of another driving operation of a driver may be detected as long as the driving operation may affect a vehicle behavior in particular, and a driving skill may be evaluated. In this case, a data set input to a correction operation cause model generated in advance may include information capable of detecting the driving operation.

Although a cause of a correction operation is selected from the correction operation cause list shown in FIG. 2 in the embodiment described above, other possible causes may be provided in the correction operation cause list.

The display of the evaluation result shown in FIG. 6 is merely an example, and contents included in the notification of the evaluation result and a form of the notification are not particularly limited.

In the above embodiments, a cause of a correction operation is estimated based on vehicle traveling state information at a time point when a correction operation is performed and vehicle traveling state information at time points before a predetermined period and after a predetermined period of the time point when the correction operation is performed. Alternatively, various kinds of information at a travel point where the correction operation is performed may be used instead of the time point when the correction operation is performed. For example, the driving skill evaluation device 10 may specify a travel point where a correction operation is performed and specify a cause of the correction operation based on vehicle traveling state information at the travel point where the correction operation is performed and vehicle traveling state information at traveling points located forward than the travel point where the correction operation is performed by a predetermined distance and located afterward than the travel point where the correction operation is performed by a predetermined distance. In this case, a driving skill of a driver can be evaluated based on a correction operation of a driving operation and a cause of the correction operation, and a driving skill evaluation system with high evaluation accuracy can be provided.

According to the present embodiment as described above, it is possible to provide an automobile driving skill evaluation system capable of improving evaluation accuracy.

The control unit 50 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the control unit 50 including the vehicle data collection unit 51, the correction operation detection unit 53, the cause estimation unit 55, the evaluation unit 57, and the notification control unit 59 illustrated in FIG. 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the control unit 50 including the vehicle data collection unit 51, the correction operation detection unit 53, the cause estimation unit 55, the evaluation unit 57, and the notification control unit 59 in FIG. 1.

What is claimed is:

1. A driving skill evaluation system configured to evaluate a driving skill of a driver, the driving skill evaluation system comprising:
a correction operation detection unit configured to detect a correction operation in a driving operation of the driver;
a cause estimation unit configured to perform an estimation of a cause of the correction operation based on vehicle traveling state information at a time point when the correction operation is performed and vehicle traveling state information at time points before a predetermined period and after a predetermined period of the time point; and
an evaluation unit configured to evaluate the driving skill of the driver based on a result of the estimation.

2. The driving skill evaluation system according to claim 1,
wherein the cause estimation unit is configured to estimate the cause of the correction operation based on
a correction operation cause model,
the vehicle traveling state information at a time point when the correction operation is performed, and
the vehicle traveling state information at time points before a predetermined period and after a predetermined period of the time point when the correction operation is performed,
wherein input data of the correction operation cause model includes
vehicle traveling scene information at the time point when the correction operation is performed,
vehicle control information at time points before a predetermined period and after a predetermined period of the time point when the correction operation is performed,
vehicle surrounding environment information at time points before a predetermined period and after a predetermined period of the time point when the correction operation is performed, and
a cause of the correction operation,
wherein the vehicle traveling state information at the time point when the correction operation is performed includes the vehicle traveling scene information at the time point when the correction operation is performed, and
wherein the vehicle traveling state information at time points before a predetermined period and after a predetermined period of the time point when the correction operation is performed includes
the vehicle control information at time points before a predetermined period and after a predetermined period of the time point when the correction operation is performed, and
the vehicle surrounding environment information at time points before a predetermined period and after a predetermined period of the time point when the correction operation is performed.

3. The driving skill evaluation system according to claim 1,
wherein the evaluation unit
does not perform a negative evaluation for the driving skill when the cause estimation unit estimates that a cause of the correction operation is an unavoidable operation in a traveling environment of the vehicle, and
performs a negative evaluation for the driving skill when the cause estimation unit estimates that a cause of the correction operation is a cause that is not an unavoidable operation in a traveling environment of the vehicle.

4. The driving skill evaluation system according to claim 1,
wherein the driving operation includes a steering operation for adjusting a steering angle, and
wherein the correction operation detection unit
determines that a steering switching-back occurs when, after a turning direction of a steering wheel is switched from right to left or from left to right, a rotation amount of the steering wheel in a direction after the switching is equal to or larger than a predetermined switching-back determination threshold, and
detects a correction operation of the steering operation when, after a steering switching-back from one direction to another direction is detected, a steering switching-back from the another direction to the one direction is detected before a travel distance reaches a predetermined distance threshold.

5. The driving skill evaluation system according to claim 4,
wherein the distance threshold is set according to a traveling scene of the vehicle.

6. The driving skill evaluation system according to claim 1,
wherein the driving operation includes a steering operation for adjusting a steering angle, and
wherein the correction operation detection unit
determines that a steering switching-back occurs when, after a turning direction of a steering wheel is switched from right to left or from left to right, a rotation amount of the steering wheel in a direction after the switching is equal to or larger than a predetermined switching-back determination threshold, and
detects a correction operation of the steering operation when, after a steering switching-back from one direction to another direction is detected, a steering switching-back from the another direction to the one direction is detected within a predetermined period of time.

7. The driving skill evaluation system according to claim 6,
wherein the predetermined period of time is set according to a traveling scene of the vehicle.

8. The driving skill evaluation system according to claim 1,
wherein the driving operation includes an operation for adjusting a front-rear direction acceleration, and
wherein the correction operation detection unit detects a correction operation of the driving operation when an elapsed time starting from a time point when an acceleration exceeds a predetermined acceleration threshold is equal to or larger than a predetermined period of time.

9. A driving skill evaluation method comprising:
detecting a correction operation in a driving operation of a driver;
performing an estimation of a cause of the correction operation based on vehicle traveling state information at a time point when the correction operation is performed and vehicle traveling state information at time points before a predetermined period and after a predetermined period of the time point when the correction operation is performed; and
evaluating a driving skill of the driver based on a result of the estimation.

10. A driving skill evaluation system configured to evaluate a driving skill of a driver, the driving skill evaluation system comprising a circuitry configured to:
detect a correction operation in a driving operation of the driver;
perform an estimation of a cause of the correction operation based on vehicle traveling state information at a time point when the correction operation is performed and vehicle traveling state information at time points before a predetermined period and after a predetermined period of the time point; and
evaluate the driving skill of the driver based on a result of the estimation.
